(19) United States
(12) Patent Application Publication
(10) Pub. No.: US 2006/0227129 A1
(43) Pub. Date: Oct. 12, 2006

(54) Mobile communication terminal and method

(76) Inventor: Cheng Peng, Nearum (DK)

Correspondence Address: PERMAN & GREEN, 425 POST ROAD, FAIRFIELD, CT, 06824, US

(21) Appl. No.: 11/094,845

(22) Filed: Mar. 30, 2005

(51) Int. Cl. G06T 15/00

(52) U.S. Cl. 345/419

(57) ABSTRACT

A mobile communication apparatus comprising a processor and a user interface UI is disclosed. The UI comprises a display and an input means, the input means is arranged to sense a three-dimensional direction, the processor is arranged to assign three-dimensional spatial data to said three-dimensional direction and to a plurality of items, and the display is arranged to view the three-dimensional items and the three-dimensional direction according to the three-dimensional spatial data. An input method for the mobile communication apparatus is also disclosed.

### TECHNICAL FIELD

The present invention relates to a mobile communication apparatus comprising input means able to perform three-dimensional input, and an input method for said mobile communication apparatus.

### BACKGROUND OF THE INVENTION

In mobile communication apparatuses, input for e.g. navigation is often performed with a four-way navigation key, sometimes formed as a joystick, to control e.g. a highlight bar displayed on a screen of the mobile communication apparatus. German patent application with publication no. DE10306322 discloses a mobile telephone with a navigation input, with which a pointer element is jogged on the display. Although this provides a quite intuitive input for navigation, there are a few drawbacks, such that the user has to scroll the highlighted bar through other items to get the desired one, and that the two-dimensional input provided by the four-way navigation key does not form a feasible input when it comes to three-dimensional graphical user interfaces. Therefore, there is a need for an improved input for navigation among items in a mobile communication apparatus.

### SUMMARY OF THE INVENTION

In view of the above, an objective of the invention is to solve or at least reduce the problems discussed above. In particular, an objective is to provide an intuitive input in a graphical user interface of a mobile communication apparatus.

The objective is achieved according to a first aspect of the present invention by a mobile communication apparatus comprising a processor and a user interface UI, wherein said UI comprises a display and an input means, said input means is arranged to sense a three-dimensional direction, said processor is arranged to assign three-dimensional spatial data to said three-dimensional direction and to a plurality of three-dimensional items, and said display is arranged to view said three-dimensional items and said three-dimensional direction according to said three-dimensional spatial data.

An advantage of this is a direct input of pointing towards a displayed item.

The input means may comprise a curved touch pad, wherein said three-dimensional direction is associated with a normal to a touched portion of said curved touch pad.

An advantage of this is that an object, e.g. a finger of a user, pointing in a direction and touching the input means will transfer the pointing direction through the input means to become the three-dimensional direction used in the mobile communication apparatus. Thereby, a very intuitive input is provided.

The input means may comprise a joystick, and said three-dimensional direction is associated with a direction of said joystick.

An advantage of this is that a direction associated with the joystick, e.g. a virtual extension of the joystick, will transfer the joystick direction through the input means to become the three-dimensional direction used in the mobile communication apparatus.

The input means may comprise a trackball, wherein said three-dimensional direction is associated with a predefined direction of said trackball. The trackball may comprise a recess for actuating said trackball, wherein said predefined direction of said trackball is associated with said recess.

An advantage of this is that a direction associated with the trackball, e.g. a virtual extension of the recess of the trackball, in which a finger of a user may be inserted, wherein the direction will be a virtual extension of the user's finger, will transfer the trackball direction through the input means to become the three-dimensional direction used in the mobile communication apparatus.

The input means comprises a device with a fixed part and a movable part, wherein said fixed part comprises a recess, said recess of said fixed part comprises a curved surface, said movable part comprises a curved surface, and said curved surfaces of said recess of said fixed part and said movable part are facing each other and have similar form to enable said movable part to slide in two directions of freedom in relation to said fixed part, wherein said three-dimensional direction is associated with a direction of said movable part.

The input means may comprise a curved recess and an optical registration unit arranged to register movement and position of a user's finger when said finger is inserted in said recess, wherein said three-dimensional direction is a registered direction of said finger.

The view of said three dimensional direction may be illustrated as a ray. An advantage of this is the intuitive connection to the user's action. Everyone knows how to illuminate something with a flashlight, and the user will experience the same intuitive and direct interaction with the UI according to the present invention.

The ray may virtually illuminate said three-dimensional items when virtually hitting them.

The input means may be arranged in relation to said display such that said three dimensional direction is virtually veiwed on said display such that it coincides with an actual three-dimensional direction of an object associated with said input means.

An advantage of this is that the three-dimensional direction will be experienced as an extension of the object associated with the input means, e.g. a direction of a user's finger actuating the input means, or a part of the input means actuated by a user, all the way to the display.

The items may be menu items.

The object is achieved according to a second aspect of the present invention by an input method for a mobile communication apparatus comprising a display and an input means, comprising the steps of: sensing a three-dimensional direction by said input means; and viewing said three-dimensional direction and one or more three-dimensional items on said display.

Viewing said three-dimensional direction may comprise viewing a ray.

The method may further comprise the step of virtually illuminating an item when hit by said ray.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one in-stance of said element, device, component, means, step, etc., unless explicitly stated otherwise. The steps of any method dis-closed herein do not have to be performed in the exact order disclosed, unless explicitly stated.

Other objectives, features and advantages of the present invention will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIGS. 1a to 1c illustrates a mobile communication apparatus according to an embodiment of the present invention;

FIG. 2 is a schematic block diagram of a mobile communication apparatus according to an embodiment of the present invention;

FIG. 3 illustrates a part of a mobile communication apparatus according to an embodiment of the present invention, and forming of a virtual three-dimensional space containing three-dimensional items and a virtual ray corresponding to an input;

FIG. 4 illustrates the use of a mobile communication apparatus according to an embodiment of the present invention;

FIG. 5 is a flow chart illustrating an input method according to an embodiment of the present invention;

FIG. 6 illustrates a part of a mobile communication apparatus according to an embodiment of the present invention;

FIG. 7 illustrates a part of a mobile communication apparatus according to an embodiment of the present invention;

FIG. 8 is a section view of a part of a mobile communication apparatus according to an embodiment of the present invention, comprising an input means;

FIG. 9 is a section view of a part of a mobile communication apparatus according to an embodiment of the present invention, comprising an input means; and

FIG. 10 is a section view of a part of a mobile communication apparatus according to an embodiment of the present invention, comprising an input means.

### DETAILED DESCRIPTION OF PREFERRED EMBODIMENTS

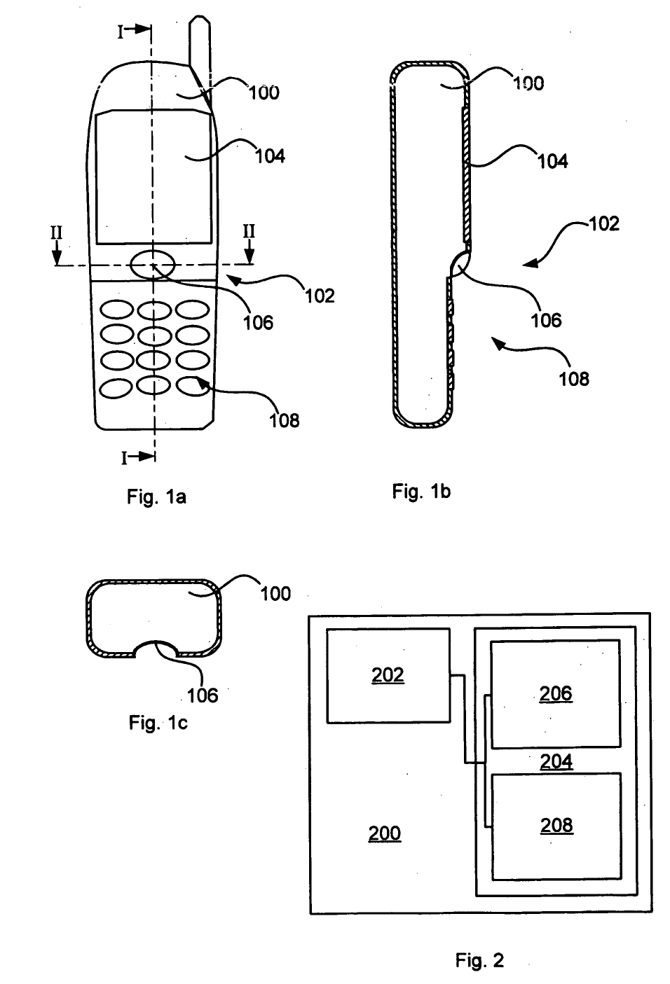

FIGS. 1a to 1c illustrates a mobile communication apparatus 100 according to an embodiment of the present invention. FIG. 1a is a front view of the mobile communication apparatus 100. FIG. 1b is a schematical section along the line I-I of FIG. 1a, where interior electronics, mechanics, etc. of the mobile communication apparatus 100 have been omitted for clarity reasons. FIG. 1c is a schematical section along the line II-II of FIG. 1a, where interior electronics, mechanics, etc. of the mobile communication apparatus 100 have been omitted for clarity reasons.

The mobile communication apparatus comprises a user interface UI 102 comprising input means and output means, where the output means comprises a display 104, and the input means comprises a curved touch sensitive input means 106 arranged to sense a three-dimensional direction. The input means can also comprise one or more keys 108.

The display 104 is arranged to form a three-dimensional graphical user inteface, i.e. to view items such that they appear as three-dimensional objects in a three-dimensional space to a user. For example, the items can be menu items, objects in a game, icons, etc.

The direction sensed by the curved touch sensitive input means 106 can be assigned to be a normal to the surface at a point of the curved touch sensitive input means 106 where a touch is detected. The input means 106 is curved in two directions, thereby enabling a direction to be determined in both elevation and azimuth. The direction is used to point at items viewed on the display 104. Therefore, a virtual three-dimensional space is formed, where three-dimensional positions of the items and a three-dimensional extension of the direction, e.g. as a ray from a spotlight, are assigned, and then viewed by the display 104. The display 104 can form the view by a true three-dimensional viewing, or by forming an appearance of three-dimensional viewing, e.g. by applying a perspective view.

FIG. 2 is a schematical block diagram of a mobile communication apparatus 200 according to an embodiment of the present invention. The mobile communication apparatus 200 comprises a processor 202 and a user interface UI 204. The UI comprises a display 206 and an input means 208 arranged to sense a three-dimensional direction. The processor 202 is arranged to control the UI 204, e.g. forming a virtual three-dimensional space, where three-dimensional positions of items of a three-dimensional graphical UI and a three-dimensional extension of the sensed direction, e.g. as a ray from a spotlight or a laser beam, are assigned, and then viewed by the display 206. The display 206 can form the view by a true three-dimensional viewing, or by forming an appearance of three-dimensional viewing, e.g. by applying a perspective view. The input means 208 can sense the three-dimensional direction by touch of a part of the input means and the processor assigns a direction associated with that part of the input means. For example, the direction can be a virtual direction related to a normal of the surface of the input means 208 at the touched part.

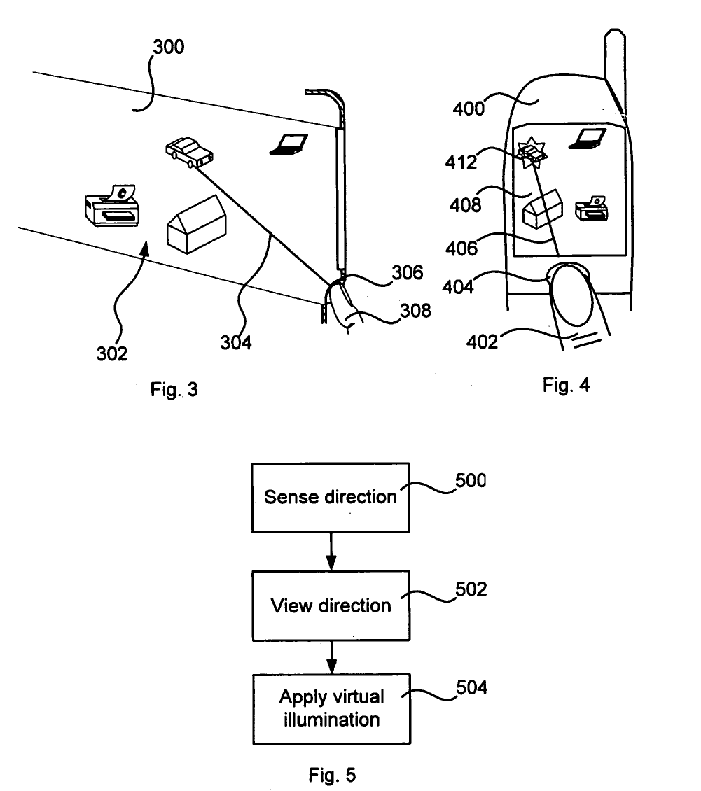

FIG. 3 illustrates a part of a mobile communication apparatus according to an embodiment of the present invention, and forming of a virtual three-dimensional space 300 containing three-dimensional items 302 and a virtual ray 304 corresponding to a touch of a input means 306 arranged to sense a three-dimensional direction. The touch can be performed by a finger 308, e.g. a thumb, of a user.

FIG. 4 illustrates the use of a mobile communication apparatus 400 according to an embodiment of the present invention. A finger 402 of a user touches an input means 404 arranged to sense a three-dimensional direction. The sensed direction is viewed as a ray 406 on a display 408 of the mobile communication apparatus 400, together with a view of three-dimensional items 408. An item 412 hit by the virtual ray 406 can be highlighted to facilitate selection, and the direction of the ray 406 can be adjusted to ease aiming, and thus further facilitate for a user.

FIG. 5 is a flow chart illustrating an input method according to an embodiment of the present invention. In a direction sensing step 500, a three-dimensional direction is sensed by an input means. In a direction viewing step 502, a virtual direction is viewed, e.g. as a ray from a spotlight or a laser, on a screen together with one or more three-dimensional items. If an item is hit by the virtual ray, i.e. any point taken in three dimensionals of the virtual ray coincides with a virtual three-dimensional position of an item, the hit item can be illuminated or high-lighted as being viewed on the display in a virtual illumination step 504. The user can select a hit and, preferably, high-lighted item, which is associated with a function of the mobile communication apparatus. The above described steps 500 to 504 are typically part of a real-time operation, and can therefore be performed in any order, or parallelly.

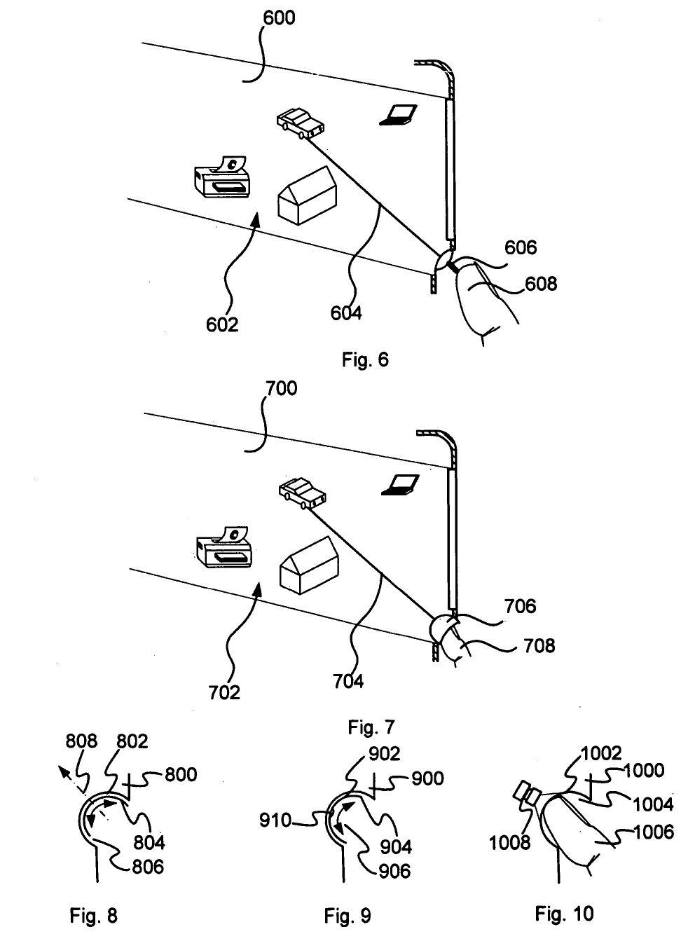

FIG. 6 illustrates a part of a mobile communication apparatus according to an embodiment of the present invention. A virtual three-dimensional space 600 containing three-dimensional items 602 and a virtual ray 604 corresponding to an actuation of a input means 606 arranged to sense a three-dimensional direction. The input means 606 is formed as a joystick, where the three-dimensional direction is associated with a direction of said joystick. The three-dimensional direction can be a virtual extension of the joystick. The actuation can be performed by a finger 608, e.g. a thumb, of a user.

FIG. 7 illustrates a part of a mobile communication apparatus according to an embodiment of the present invention. A virtual three-dimensional space 700 containing three-dimensional items 702 and a virtual ray 704 corresponding to an actuation of a input means 706 arranged to sense a three-dimensional direction. The input means 706 is formed as a trackball with a recess, where the three-dimensional direction is associated with a direction of said trackball which in turn is associated with said recess. The actuation can be performed by a finger 708, e.g. a thumb, of a user inserted into said recess. Thereby, the three-dimensional direction is experienced by the user to be the extension of the user's finger 708 inserted into said recess, where the trackball of the input means 706 follows the movements of the finger 708.

FIG. 8 is a section view of a part of a mobile communication apparatus 800 according to an embodiment of the present invention, comprising an input means 802. The input means 802 is formed as a cup or bowl 804 movable inside a corresponding recess 806, thereby enabling a principal direction 808 of the cup or bowl 804 to form a three-dimensional direction. The recess 806 can be spherical, i.e. the part of a sphere coinciding with the housing of the mobile communication apparatus 800. The movements and actual position of the cup or bowl 804 of the input means 802 can for example be determined optically, magnetically, or by electromechanical sensors. A predetermined direction of the cup or bowl 804 is used as a three-dimensional direction in a user interface, as described above.

FIG. 9 is a section view of a part of a mobile communication apparatus 900 according to an embodiment of the present invention, comprising an input means 902. The input means 902 is formed as a cup or bowl 904 movable inside a corresponding recess 906. The movements and actual position of the cup or bowl 904 of the input means 902 can for example be determined optically, magnetically, or by electromechanical sensors. Inside the cup or bowl 904, a tactile marking 910, e.g. a swelling or a small knob, is provided to enable a user to better feel the actual direction of the cup or bowl 904, which is used as a three-dimensional direction in a user interface, as described above.

FIG. 10 is a section view of a part of a mobile communication apparatus 1000 according to an embodiment of the present invention, comprising an input means 1002. The input means 1002 is formed as a recess 1004, in which a user can put a finger 1006 to point out a three-dimensional direction. The movements and actual position of the finger 1006 in the input means 1002 can be optically registered, for example by a camera or image registering device 1008 registering movements and position of an image of the finger to determine a direction of the finger. The determined direction of the finger is used as a three-dimensional direction in a user interface, as described above.

The invention has mainly been described above with reference to a few embodiments. However, as is readily appreciated by a person skilled in the art, other embodiments than the ones disclosed above are equally possible within the scope of the invention, as defined by the appended patent claims.

1. A mobile communication apparatus comprising a processor and a user interface UI, wherein said UI comprises a display and an input means, said input means is arranged to sense a three-dimensional direction, said processor is arranged to assign three-dimensional spatial data to said three-dimensional direction and to a plurality of three-dimensional items, and said display is arranged to view said three-dimensional items and said three-dimensional direction according to said three-dimensional spatial data.

2. The mobile communication apparatus according to claim 1, wherein said input means comprises a curved touch pad, and said three-dimensional direction is associated with a normal to a touched portion of said curved touch pad.

3. The mobile communication apparatus according to claim 1, wherein said input means comprises a joystick, and said three-dimensional direction is associated with a direction of said joystick.

4. The mobile communication apparatus according to claim 1, wherein said input means comprises a trackball, and said three-dimensional direction is associated with a predefined direction of said trackball.

5. The mobile communication apparatus according to claim 4, wherein said trackball comprises a recess for actuating said trackball, wherein said predefined direction of said trackball is associated with said recess.

6. The mobile communication apparatus according to claim 1, wherein said input means comprises a device with a fixed part and a movable part, wherein said fixed part comprises a recess, said recess of said fixed part comprises a curved surface, said movable part comprises a curved surface, and said curved surfaces of said recess of said fixed part and said movable part are facing each other and have similar form to enable said movable part to slide in two directions of freedom in relation to said fixed part, wherein said three-dimensional direction is associated with a direction of said movable part.

7. The mobile communication apparatus according to claim 1, wherein said input means comprises a curved recess and an optical registration unit arranged to register movement and position of a user's finger when said finger is inserted in said recess, wherein said three-dimensional direction is a registered direction of said finger.

8. The mobile communication apparatus according to claim 1, wherein said view of said three dimensional direction is illustrated as a ray.

9. The mobile communication apparatus according to claim 8, wherein said ray virtually illuminates a three-dimensional item when said ray virtually hits said three-dimensional item.

10. The mobile communication apparatus according to claim 1, wherein said input means is arranged in relation to said display such that said three-dimensional direction is virtually veiwed on said display such that it coincides with an actual three dimensional direction of an object associated with said input means.

11. The mobile communication apparatus according to claim 1, wherein said items are menu items.

12. An input method for a mobile communication apparatus comprising a display and an input means, comprising the steps of:
sensing a three-dimensional direction by said input means; and
viewing said three-dimensional direction and one or more three-dimensional items on said display.

13. The method according to claim 12, wherein viewing said three-dimensional direction comprises viewing a ray.

14. The method according to claim 13, further comprising the step of virtually illuminating an item when virtually hit by said ray.

15. The method according to claim 12, wherein said items are menu items.
